(19) United States
(12) Patent Application Publication
(10) Pub. No.: US 2023/0422290 A1
(43) Pub. Date: Dec. 28, 2023

(54) CHOOSING RANDOM SELECTION OR PARTIAL SENSING FOR SIDELINK RESOURCE SELECTION

(71) Applicant: QUALCOMM Incorporated, San Diego, CA (US)

(72) Inventors: Ramprasad MAJJARI, Nellore (IN); Bapineedu Chowdary GUMMADI, Hyderabad (IN)

(21) Appl. No.: 17/808,378

(22) Filed: Jun. 23, 2022

(51) Int. Cl. H04W 72/10

(52) U.S. Cl. CPC H04W 72/10

(57) ABSTRACT

Various aspects of the present disclosure generally relate to wireless communication. In some aspects, a user equipment (UE) may use random selection to select sidelink resources when a channel busy ratio (CBR) associated with a sidelink channel satisfies a CBR threshold. Alternatively, the UE may use partial sensing to select the sidelink resources when a block error ratio (BLER) associated with the sidelink channel fails to satisfy a BLER threshold. Accordingly, the UE may transmit on the sidelink channel using the sidelink resources. Numerous other aspects are provided.

### FIELD OF THE DISCLOSURE

Aspects of the present disclosure generally relate to wireless communication and specifically, to techniques and apparatuses for choosing random selection or partial sensing for sidelink resource selection.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband interne access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

When communicating on a sidelink channel (or on an unlicensed channel), a UE (or a network entity) may use random selection or partial sensing when selecting resources for transmission. However, random selection results in an increased chance of collisions, which result in retransmissions that consume additional power and processing resources. On the other hand, partial sensing consumes additional power and processing resources in order to perform sensing prior to transmitting.

### SUMMARY

Some aspects described herein relate to a method of wireless communication performed by a user equipment (UE). The method may include using random selection to select sidelink resources when a channel busy ratio (CBR) associated with a sidelink channel satisfies a CBR threshold. The method may include transmitting on the sidelink channel using the sidelink resources.

Some aspects described herein relate to a method of wireless communication performed by a UE. The method may include using partial sensing to select sidelink resources when a block error ratio (BLER) associated with a sidelink channel fails to satisfy a BLER threshold. The method may include transmitting on the sidelink channel using the sidelink resources.

Some aspects described herein relate to an apparatus for wireless communication at a UE. The apparatus may include a memory and one or more processors coupled to the memory. The one or more processors may be configured to use random selection to select sidelink resources when a CBR associated with a sidelink channel satisfies a CBR threshold. The one or more processors may be configured to transmit on the sidelink channel using the sidelink resources.

Some aspects described herein relate to an apparatus for wireless communication at a UE. The apparatus may include a memory and one or more processors coupled to the memory. The one or more processors may be configured to use partial sensing to select sidelink resources when a BLER associated with a sidelink channel fails to satisfy a BLER threshold. The one or more processors may be configured to transmit on the sidelink channel using the sidelink resources.

Some aspects described herein relate to a non-transitory computer-readable medium that stores a set of instructions for wireless communication by a UE. The set of instructions, when executed by one or more processors of the UE, may cause the UE to use random selection to select sidelink resources when a CBR associated with a sidelink channel satisfies a CBR threshold. The set of instructions, when executed by one or more processors of the UE, may cause the UE to transmit on the sidelink channel using the sidelink resources.

Some aspects described herein relate to a non-transitory computer-readable medium that stores a set of instructions for wireless communication by a UE. The set of instructions, when executed by one or more processors of the UE, may cause the UE to use partial sensing to select sidelink resources when a BLER associated with a sidelink channel fails to satisfy a BLER threshold. The set of instructions, when executed by one or more processors of the UE, may cause the UE to transmit on the sidelink channel using the sidelink resources.

Some aspects described herein relate to an apparatus for wireless communication. The apparatus may include means for using random selection to select sidelink resources when a CBR associated with a sidelink channel satisfies a CBR threshold. The apparatus may include means for transmitting on the sidelink channel using the sidelink resources.

Some aspects described herein relate to an apparatus for wireless communication. The apparatus may include means for using partial sensing to select sidelink resources when a BLER associated with a sidelink channel fails to satisfy a BLER threshold. The apparatus may include means for transmitting on the sidelink channel using the sidelink resources.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIGS. 3A and 3B are diagrams illustrating examples of sidelink sensing in accordance with the present disclosure.

FIG. 4 is a diagram illustrating an example associated with choosing random selection or partial sensing for sidelink resource selection in accordance with the present disclosure.

FIGS. 5 and 6 are flowcharts illustrating example processes performed, for example, by a UE in accordance with the present disclosure.

FIG. 7 is a diagram of an example apparatus for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to choosing between random selection or partial sensing on a sidelink channel. Some aspects more specifically relate to using a channel busy ratio (CBR) associated with the sidelink channel to choose between random selection or partial sensing. In some aspects, a UE may use a priority associated with a message in combination with the CBR associated with the sidelink channel to select resources for transmission. Some aspects more specifically relate to using a block error rate (BLER) associated with the sidelink channel to choose between random selection or partial sensing. In some aspects, the UE may use a priority associated with a message in combination with the BLER associated with the sidelink channel to select resources for transmission. In some aspects, the UE may use a combination of a priority associated with a message, a CBR associated with the sidelink channel, and the BLER associated with the sidelink channel to select resources for transmission.

Particular aspects of the subject matter described in this disclosure can be implemented to realize one or more of the following potential advantages. In some examples, the described techniques can be used to conserve power and processing resources by refraining from using partial sensing when the CBR satisfies a CBR threshold or the BLER satisfies a BLER threshold. Similarly, the described techniques can be used to reduce chances of retransmissions (which, in turn, conserves power and processing resources) by using partial sensing when the CBR fails to satisfy the CBR threshold or the BLER fails to satisfy the BLER threshold.

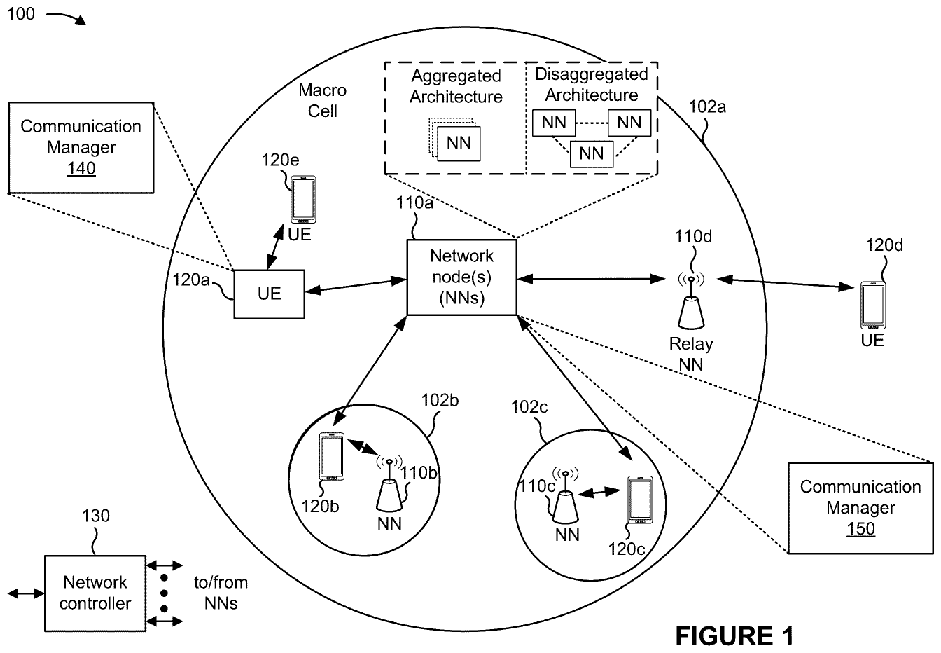

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may use random selection to select sidelink resources when a CBR associated with a sidelink channel satisfies a CBR threshold and transmit on the sidelink channel using the sidelink resources. Alternatively, the communication manager 140 may use partial sensing to select sidelink resources when a BLER associated with a sidelink channel fails to satisfy a BLER threshold and transmit on the sidelink channel using the sidelink resources. Additionally or alternatively, the communication manager 140 may perform one or more other operations described herein.

In some aspects, the network node 110 may include a communication manager 150. As described in more detail elsewhere herein, the communication manager 150 may use random selection to select unlicensed resources when a CBR associated with an unlicensed channel satisfies a CBR threshold and transmit on the unlicensed channel using the unlicensed resources. Alternatively, the communication manager 150 may use partial sensing to select unlicensed resources when a BLER associated with an unlicensed channel fails to satisfy a BLER threshold and transmit on the unlicensed channel using the unlicensed resources. Additionally or alternatively, the communication manager 150 may perform one or more other operations described herein.

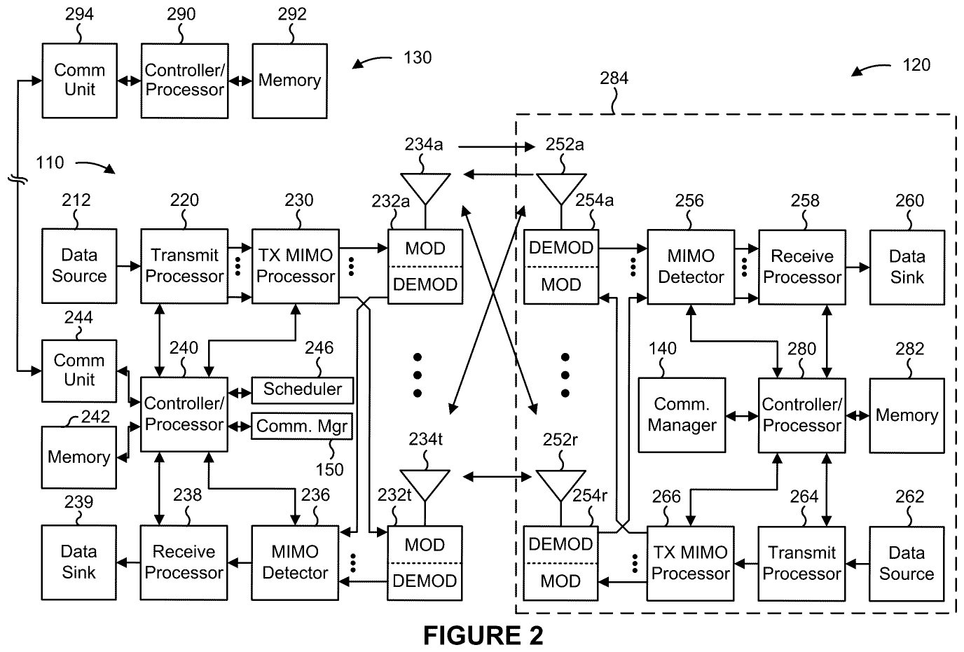

FIG. 2 is a diagram illustrating an example network node in communication with a user equipment (UE) in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T>1). The UE 120 may be equipped with a set of antennas 252a through 252r, such as R antennas (R>1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MC S(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

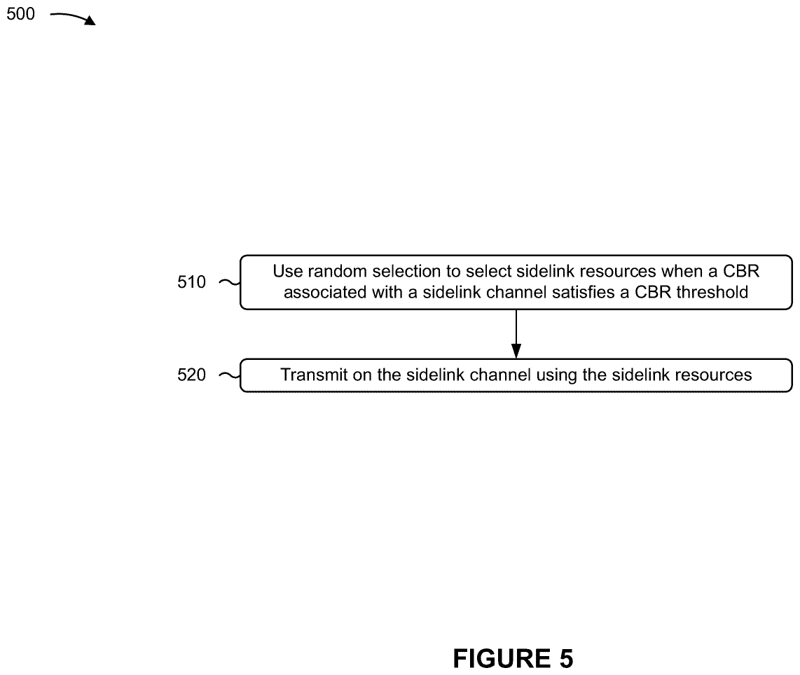

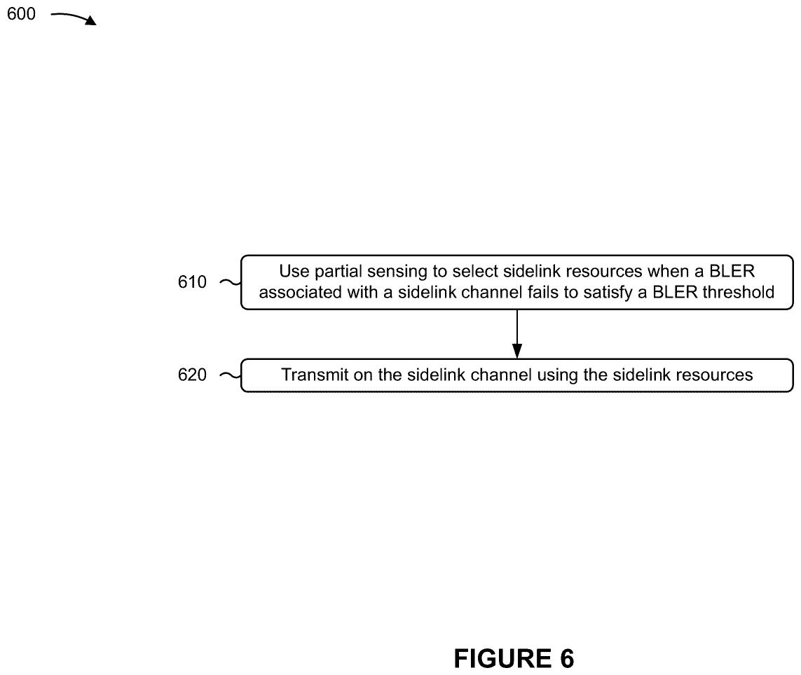

The controller/processor 240 of the network node 110, the controller/processor 280 of the UE 120, or any other component(s) of FIG. 2 may perform one or more techniques associated with choosing random selection or partial sensing for sidelink resource selection, as described in more detail elsewhere herein. For example, the controller/processor 240 of the network node 110, the controller/processor 280 of the UE 120, or any other component(s) of FIG. 2 may perform or direct operations of, for example, process 500 of FIG. 5, process 600 of FIG. 6, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 500 of FIG. 5, process 600 of FIG. 6, or other processes as described herein. In some examples, executing instructions may include running the instructions, converting the instructions, compiling the instructions, or interpreting the instructions, among other examples.

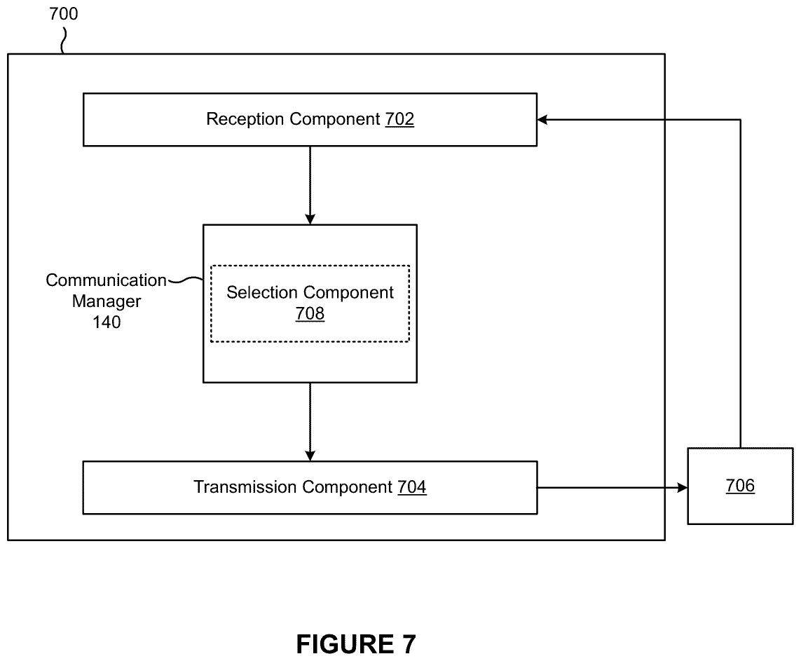

In some aspects, a UE (such as the UE 120 or apparatus 700 of FIG. 7) may include means for using random selection to select sidelink resources when a CBR associated with a sidelink channel satisfies a CBR threshold; means for using partial sensing to select sidelink resources when a BLER associated with a sidelink channel fails to satisfy a BLER threshold; or means for transmitting on the sidelink channel using the sidelink resources. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (such as the network node 110) may include means for using random selection to select unlicensed resources when a CBR associated with an unlicensed channel satisfies a CBR threshold; means for using partial sensing to select unlicensed resources when a BLER associated with an unlicensed channel fails to satisfy a BLER threshold; or means for transmitting on the unlicensed channel using the unlicensed resources. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

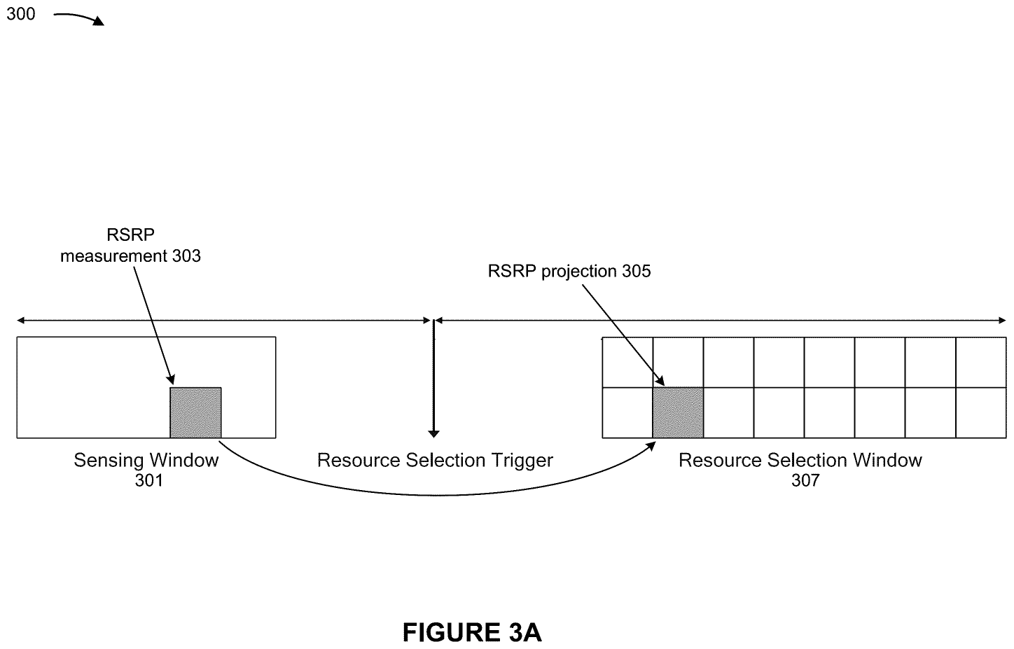

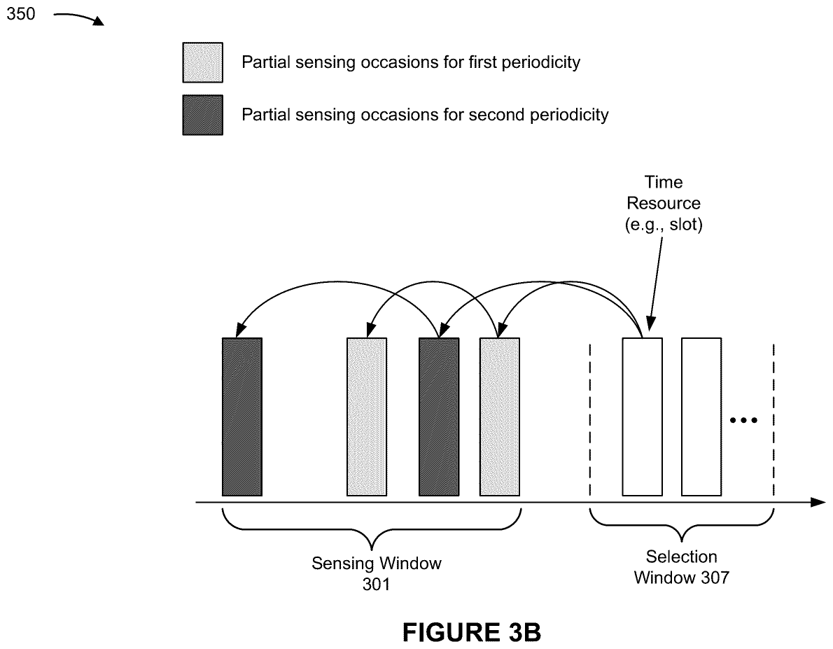

FIG. 3A is a diagram illustrating an example 300 of sidelink sensing in accordance with the present disclosure. As shown in FIG. 3A, a UE (such as a UE 120) may use a sensing procedure to select resources for sidelink communication, such as described in connection with FIG. 3A.

As shown in FIG. 3A, the UE 120 may perform a sensing procedure in a sensing window 301. In some cases, the sensing window 301 may be 100 microseconds (ms) (for example, for aperiodic resource reservation) or 1100 ms (for example, for periodic resource reservation).

According to the sensing procedure, the UE 120 may decode control messages relating to resource reservations of other UEs, as well as perform measurements (for example, RSSI measurements and/or RSRP measurements) of one or more sidelink channels (for example, one or more sub-channels associated with the resource reservations). The UE 120 may perform the measurements (for example, RSRP measurement 303) in the sensing window 301. The measurements in the sensing window 301 may be projected (for example, to RSRP projection 305) onto the resource reservations in the resource selection window 307, as shown.

As further shown in FIG. 3A, the UE 120 may determine to select resources for a sidelink communication based at least in part on a resource selection trigger. For example, resource selection may be triggered when the UE 120 has a packet that is to be transmitted. Based at least in part on the resource selection trigger, the UE 120 may determine one or more resources that are available for selection in the resource selection window 307. That is, the UE 120 may determine the one or more available resources based at least in part on the sensing procedure performed by the UE 120 (or example, based at least in part on the measurements performed by the UE 120 in the sensing window 301). For example, the sensing procedure may provide an indication of resources in the resource selection window 307 that are occupied or resources in the resource selection window 307 associated with high interference. In some examples, the UE 120 may compare the measurements projected onto the resource selection window 307 with a threshold. The UE 120 may increase the threshold until a percentage (for example, having a configurable value) of the resources are associated with measurements that satisfy the threshold. The UE 120 may determine that resources associated with measurements failing to satisfy the threshold are occupied.

FIG. 3B is a diagram illustrating an example 350 of sidelink sensing in accordance with the present disclosure. As shown in FIG. 3B, a UE (such as a UE 120) may use a partial sensing procedure to select resources for sidelink communication, such as described in connection with FIG. 3A. For example, a partialSensing variable in an SL-P2X-ResourceSelectionConfig data structure (for example, as defined in 3GPP specifications or another standard) may indicate that the UE 120 should perform partial sensing before transmitting. Alternatively, the UE 120 may communicate on an unlicensed channel (for example, an NR unlicensed (NR-U) channel) such that the UE 120 performs partial sensing before transmitting.

In some examples, partial sensing may be used to sense periodic interference associated with periodic transmissions. According to the partial sensing procedure, the UE 120 may perform sensing in a set of partial sensing occasions, where the partial sensing occasions are separated from one another by time gaps. Thus, in partial sensing, the UE 120 does not perform sensing continuously in a sensing window 301 (such sensing may be referred to as “full sensing”), as described in connection with FIG. 3A. The partial sensing occasions may be related to a resource (for example, a time resource, such as a slot) in a resource selection window 307 in which the UE 120 is to perform a transmission. For example, a set of partial sensing occasions may include a first set of partial sensing occasions with a first time periodicity relative to (for example, before) the resource in the resource selection window 307 or a second set of partial sensing occasions with a second time periodicity relative to (for example, before) the resource in the resource selection window 307. The time periodicities that may be monitored by the UE 120 in connection with the partial sensing occasions may be indicated in a list of allowable resource reservation periodicities (for example, an sl-ResourceReservePeriodList data structure, as defined in 3GPP specifications or another standard).

Various aspects relate generally to choosing between random selection or partial sensing on a sidelink channel. Some aspects more specifically relate to using a channel busy ratio (CBR) associated with the sidelink channel to choose between random selection or partial sensing. In some aspects, a UE may use a priority associated with a message in combination with the CBR associated with the sidelink channel to select resources for transmission. Some aspects more specifically relate to using a block error rate (BLER) associated with the sidelink channel to choose between random selection or partial sensing. In some aspects, the UE may use a priority associated with a message in combination with the BLER associated with the sidelink channel to select resources for transmission. In some aspects, the UE may use a combination of a priority associated with a message, a CBR associated with the sidelink channel, and the BLER associated with the sidelink channel to select resources for transmission.

Particular aspects of the subject matter described in this disclosure can be implemented to realize one or more of the following potential advantages. In some examples, the described techniques can be used to conserve power and processing resources by refraining from using partial sensing when the CBR satisfies a CBR threshold or the BLER satisfies a BLER threshold. Similarly, the described techniques can be used to reduce chances of retransmissions (which, in turn, conserves power and processing resources) by using partial sensing when the CBR fails to satisfy the CBR threshold or the BLER fails to satisfy the BLER threshold.

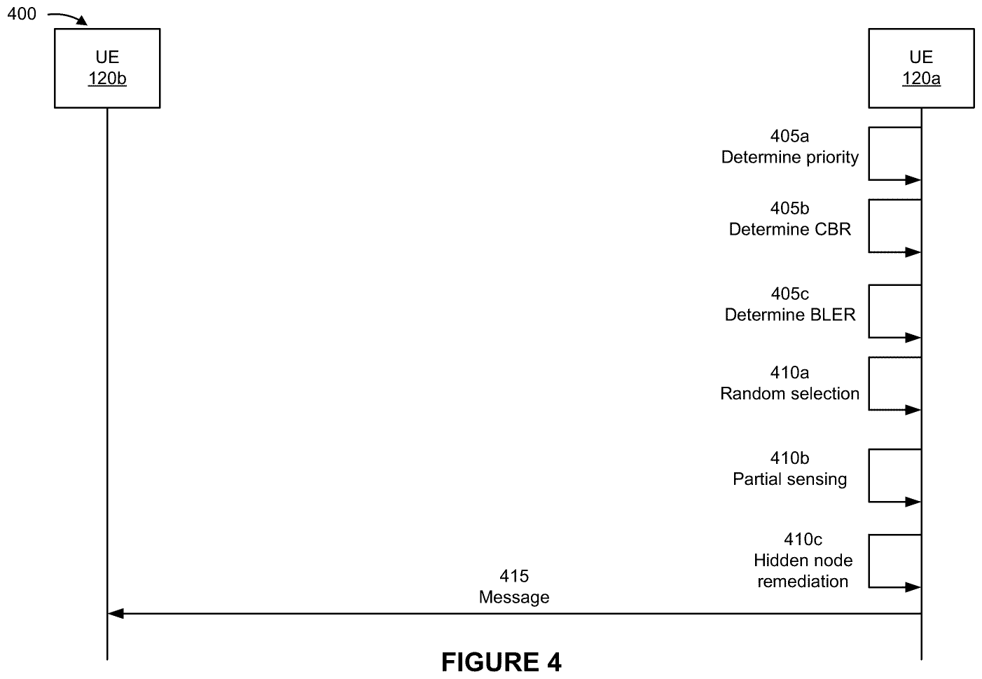

FIG. 4 is a diagram illustrating an example 400 associated with choosing random selection or partial sensing for sidelink resource selection in accordance with the present disclosure. As shown in FIG. 4, a first UE 120a communicates with a second UE 120b on a sidelink channel.

In a first operation 405a, the UE 120a may determine a priority associated with information (such as a message or another type of information, such as control information) to be transmitted on the sidelink channel (for example, to the UE 120b). For example, the UE 120a may determine the priority based on a quality of service (QoS) associated with the information.

Accordingly, the UE 120a may select between random selection and partial sensing based on the priority. For example, the UE 120a may use partial sensing to select sidelink resources for transmitting the information when the priority satisfies a priority threshold. As a result, the UE 120a increases reliability when transmitting the information. Similarly, the UE 120a may use random selection to select sidelink resources for transmitting the information when the priority fails to satisfy the priority threshold. As a result, the UE 120a conserves power and processing resources that would otherwise have been used for partial sensing.

Additionally or alternatively, and in a second operation 405b, the UE 120a may determine a CBR associated with the sidelink channel. For example, the UE 120a may determine the CBR based on measurements (such as RSRP measurements) performed on the sidelink channel or based on historical transmissions (for example, from the UE 120a) on the sidelink channel.

Accordingly, the UE 120a may select between random selection and partial sensing based on the CBR. For example, the UE 120a may use partial sensing to select sidelink resources for transmitting the information when the CBR fails to satisfy a CBR threshold. In this example, the CBR threshold is set to indicate when the CBR is sufficiently low (e.g., to allow for random selection), so the CBR will fail to satisfy the CBR threshold when the CBR is greater than (or equal to) the CBR threshold. As a result, the UE 120a increases reliability when transmitting the information. Similarly, the UE 120a may use random selection to select sidelink resources for transmitting the information when the CBR satisfies the CBR threshold. In this example, the CBR will satisfy the CBR threshold when the CBR is less than (or equal to) the CBR threshold. As a result, the UE 120a conserves power and processing resources that would otherwise have been used for partial sensing.

In some aspects, the UE 120a may use a combination of the priority and the CBR to select between random selection and partial sensing. For example, the combination may be sequential. Accordingly, the UE 120a may use partial sensing when the priority satisfies the priority threshold but proceed to evaluate the CBR when the priority fails to satisfy the priority threshold, or the UE 120a may use random selection when the CBR satisfies the CBR threshold but proceed to evaluate the priority when the CBR fails to satisfy the CBR threshold. Alternatively, the UE 120a may adjust the CBR threshold based on the priority (for example, decreasing the CBR threshold when the priority satisfies the priority threshold or increasing the CBR threshold when the priority fails to satisfy the priority threshold) or may adjust the priority threshold based on the CBR (for example, increasing the priority threshold when the CBR satisfies the CBR threshold or decreasing the priority threshold when the CBR fails to satisfy the CBR threshold). Alternatively, the combination may be holistic. For example, the UE 120a may calculate a score based on the priority and the CBR (such as a weighted sum of the priority and the CBR). Accordingly, the UE 120a may use random selection when the score satisfies a score threshold but use partial sensing when the score fails to satisfy the score threshold.

Additionally or alternatively, and in a third operation 405c, the UE 120a may determine a BLER associated with the sidelink channel. For example, the UE 120a may determine the BLER based on measurements (such as RSRP measurements) performed on the sidelink channel or based on historical transmissions (for example, from the UE 120a) on the sidelink channel.

Accordingly, the UE 120a may select between random selection and partial sensing based on the BLER. For example, the UE 120a may use partial sensing to select sidelink resources for transmitting the information when the BLER fails to satisfy a BLER threshold. In this example, the BLER threshold is set to indicate when the BLER is sufficiently low (e.g., to allow for random selection), so the BLER will fail to satisfy the BLER threshold when the BLER is greater than (or equal to) the BLER threshold. As a result, the UE 120a increases reliability when transmitting the information. Similarly, the UE 120a may use random selection to select sidelink resources for transmitting the information when the BLER satisfies the BLER threshold. In this example, the BLER will satisfy the BLER threshold when the BLER is less than (or equal to) the BLER threshold. As a result, the UE 120a conserves power and processing resources that would otherwise have been used for partial sensing.

In some aspects, the UE 120a may use a combination of the BLER and the CBR to select between random selection and partial sensing. For example, the combination may be sequential. Accordingly, the UE 120a may use random selection when the BLER satisfies the BLER threshold but proceed to evaluate the CBR when the BLER fails to satisfy the BLER threshold. Alternatively, the UE 120a may adjust the CBR threshold based on the BLER (for example, increasing the CBR threshold when the BLER satisfies the BLER threshold or decreasing the CBR threshold when the BLER fails to satisfy the BLER threshold). Alternatively, the combination may be holistic. For example, the UE 120a may calculate a score based on the BLER and the CBR (such as a weighted sum of the BLER and the CBR). Accordingly, the UE 120a may use random selection when the score satisfies a score threshold but use partial sensing when the score fails to satisfy the score threshold.

In some aspects, the UE 120a may use a combination of the priority and the BLER to select between random selection and partial sensing. For example, the combination may be sequential. Accordingly, the UE 120a may use partial sensing when the priority satisfies the priority threshold but proceed to evaluate the BLER when the priority fails to satisfy the priority threshold, or the UE 120a may use random selection when the BLER satisfies the BLER threshold but proceed to evaluate the priority when the BLER fails to satisfy the BLER threshold. Alternatively, the UE 120a may adjust the BLER threshold based on the priority (for example, decreasing the BLER threshold when the priority satisfies the priority threshold or increasing the BLER threshold when the priority fails to satisfy the priority threshold) or may adjust the priority threshold based on the BLER (for example, increasing the priority threshold when the BLER satisfies the BLER threshold or decreasing the priority threshold when the BLER fails to satisfy the BLER threshold). Alternatively, the combination may be holistic. For example, the UE 120a may calculate a score based on the priority and the BLER (such as a weighted sum of the priority and the BLER). Accordingly, the UE 120a may use random selection when the score satisfies a score threshold but use partial sensing when the score fails to satisfy the score threshold.

In some aspects, the UE 120a may use a combination of the BLER, the CBR, and the priority to select between random selection and partial sensing. For example, the combination may be sequential. Accordingly, the UE 120a may use partial sensing when the priority satisfies the priority threshold but proceed to evaluate the CBR and the BLER when the priority fails to satisfy the priority threshold. Alternatively, the UE 120a may adjust the BLER threshold or the CBR threshold based on the priority. Alternatively, the combination may be holistic. For example, the UE 120a may calculate a score based on the priority, the CBR, and the BLER (such as a weighted sum of the priority and the BLER). Accordingly, the UE 120a may use random selection when the score satisfies a score threshold but use partial sensing when the score fails to satisfy the score threshold.

The UE 120a may apply hysteresis to the thresholds described herein. For example, the UE 120a may determine that the CBR satisfies the CBR threshold and subsequently determine that the CBR fails to satisfy the CBR threshold based on a hysteresis value (such as a value added to, or subtracted from, the CBR threshold during subsequent uses of the CBR threshold). Similarly, the UE 120a may determine that the BLER fails to satisfy the BLER threshold and subsequently determine that the BLER satisfies the BLER threshold based on a hysteresis value (such as a value added to, or subtracted from, the BLER threshold during subsequent uses of the BLER threshold).

Therefore, as described above, the UE 120a may perform random selection (in a fourth operation 410a) or partial sensing (in a fifth operation 410b) to select sidelink resources on the sidelink channel. In some aspects, the UE 120a may perform hidden node remediation, in a sixth operation 410c. For example, the UE 120a may perform hidden node remediation when the BLER fails to satisfy the BLER threshold, but the CBR satisfies the CBR threshold. The hidden node remediation may include selecting one or more different sub-bands to use on the sidelink channel or establishing a new sidelink channel (for example, with the UE 120b).

Accordingly, in a seventh operation 415, the UE 120a may transmit (for example, to the UE 120b) a message on the sidelink channel using the sidelink resources. The UE 120a may similarly choose between random selection or partial sensing for selecting additional sidelink resources on the sidelink channel for transmitting additional messages.

By using techniques as described in connection with FIG. 4, the UE 120 conserves power and processing resources by refraining from using partial sensing when the CBR satisfies a CBR threshold or the BLER satisfies a BLER threshold. Similarly, the UE 120 reduces chances of retransmissions (which, in turn, conserves power and processing resources) by using partial sensing when the CBR fails to satisfy the CBR threshold or the BLER fails to satisfy the BLER threshold.

Although described in connection with selecting sidelink resources on a sidelink channel, the techniques described in connection with FIG. 4 apply to selecting unlicensed resources on an unlicensed channel. For example, a UE (such as UE 120) and a network node (such as network node 110) may use a priority, a CBR, a BLER, or a combination thereof to determine whether to use random selection or partial sensing before transmitting on the unlicensed channel.

FIG. 5 is a flowchart illustrating an example process 500 performed, for example, by a UE in accordance with the present disclosure. Example process 500 is an example where the UE (for example, UE 120 or apparatus 700 of FIG. 7) performs operations associated with choosing random selection or partial sensing for sidelink resource selection.

As shown in FIG. 5, in some aspects, process 500 may include using random selection to select sidelink resources when a CBR associated with a sidelink channel satisfies a CBR threshold (block 510). For example, the UE (such as by using communication manager 140 or selection component 708, depicted in FIG. 7) may use random selection to select sidelink resources when a CBR associated with a sidelink channel satisfies a CBR threshold, as described herein.

As further shown in FIG. 5, in some aspects, process 500 may include transmitting on the sidelink channel using the sidelink resources (block 520). For example, the UE (such as by using communication manager 140 or transmission component 704, depicted in FIG. 7) may transmit on the sidelink channel using the sidelink resources, as described herein.

Process 500 may include additional aspects, such as any single aspect or any combination of aspects described below or in connection with one or more other processes described elsewhere herein.

In a first additional aspect, transmitting on the sidelink channel includes transmitting a message, on the sidelink channel, that is associated with a priority that fails to satisfy a priority threshold.

In a second additional aspect, alone or in combination with the first aspect, process 500 includes using partial sensing (such as by using communication manager 140 or selection component 708) to select additional sidelink resources, and transmitting (such as by using communication manager 140 or transmission component 704) an additional message, on the sidelink channel using the additional sidelink resources, that is associated with a priority that satisfies the priority threshold.

In a third additional aspect, alone or in combination with one or more of the first and second aspects, process 500 includes using partial sensing (such as by using communication manager 140 or selection component 708) to select additional sidelink resources when an updated CBR associated with the sidelink channel fails to satisfy the CBR threshold, and transmitting (such as by using communication manager 140 or transmission component 704) on the sidelink channel using the additional sidelink resources.

In a fourth additional aspect, alone or in combination with one or more of the first through third aspects, the updated CBR fails to satisfy the CBR threshold based on a hysteresis value.

In a fifth additional aspect, alone or in combination with one or more of the first through fourth aspects, using the partial sensing includes using the partial sensing when a BLER associated with the sidelink channel fails to satisfy a BLER threshold.

In a sixth additional aspect, alone or in combination with one or more of the first through fifth aspects, process 500 includes applying a hidden node remediation (such as by using communication manager 140 or selection component 708) when a BLER associated with the sidelink channel fails to satisfy a BLER threshold.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a flowchart illustrating an example process 600 performed, for example, by a UE in accordance with the present disclosure. Example process 600 is an example where the UE (for example, UE 120 or apparatus 700 of FIG. 7) performs operations associated with choosing random selection or partial sensing for sidelink resource selection.

As shown in FIG. 6, in some aspects, process 600 may include using partial sensing to select sidelink resources when a BLER associated with a sidelink channel fails to satisfy a BLER threshold (block 610). For example, the UE (such as by using communication manager 140 or selection component 708, depicted in FIG. 7) may use partial sensing to select sidelink resources when a BLER associated with a sidelink channel fails to satisfy a BLER threshold, as described herein.

As further shown in FIG. 6, in some aspects, process 600 may include transmitting on the sidelink channel using the sidelink resources (block 620). For example, the UE (such as by using communication manager 140 or transmission component 704, depicted in FIG. 7) may transmit on the sidelink channel using the sidelink resources, as described herein.

Process 600 may include additional aspects, such as any single aspect or any combination of aspects described below or in connection with one or more other processes described elsewhere herein.

In a first additional aspect, process 600 includes using partial sensing (such as by using communication manager 140 or selection component 708) to select additional sidelink resources, and transmitting (such as by using communication manager 140 or transmission component 704) a message, on the sidelink channel using the additional sidelink resources, that is associated with a priority that satisfies a priority threshold.

In a second additional aspect, alone or in combination with the first aspect, process 600 includes using random selection (such as by using communication manager 140 or selection component 708) to select additional sidelink resources when an updated BLER associated with the sidelink channel satisfies the BLER threshold, and transmitting (such as by using communication manager 140 or transmission component 704) on the sidelink channel using the additional sidelink resources.

In a third additional aspect, alone or in combination with one or more of the first and second aspects, the updated BLER satisfies the BLER threshold based on a hysteresis value.

In a fourth additional aspect, alone or in combination with one or more of the first through third aspects, using the random selection includes using the random selection when a CBR associated with the sidelink channel satisfies a CBR threshold.

In a fifth additional aspect, alone or in combination with one or more of the first through fourth aspects, process 600 includes applying a hidden node remediation (such as by using communication manager 140 or selection component 708) when a CBR associated with the sidelink channel satisfies a CBR threshold.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication in accordance with the present disclosure. The apparatus 700 may be a UE, or a UE may include the apparatus 700. In some aspects, the apparatus 700 includes a reception component 702, a transmission component 704, and a communication manager 140, which may be in communication with one another (for example, via one or more buses). As shown, the apparatus 700 may communicate with another apparatus 706 (such as a UE, a base station, or another wireless communication device) using the reception component 702 and the transmission component 704.

In some aspects, the apparatus 700 may be configured to perform one or more operations described herein in connection with FIG. 4. Additionally or alternatively, the apparatus 700 may be configured to perform one or more processes described herein, such as process 500 of FIG. 5, process 600 of FIG. 6, or a combination thereof. In some aspects, the apparatus 700 may include one or more components of the UE described above in connection with FIG. 2.

The reception component 702 may receive communications, such as reference signals, control information, data communications, or a combination thereof, from the apparatus 706. The reception component 702 may provide received communications to one or more other components of the apparatus 700, such as the communication manager 140. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, a modem, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, the communication manager 140 may generate communications and may transmit the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described above in connection with FIG. 2. In some aspects, the transmission component 704 may be co-located with the reception component 702 in a transceiver.

The communication manager 140 may use random selection to select sidelink resources when a CBR associated with a sidelink channel satisfies a CBR threshold. Alternatively, the communication manager 140 may use partial sensing to select the sidelink resources when a BLER associated with the sidelink channel fails to satisfy a BLER threshold. Accordingly, the communication manager 140 may transmit or may cause the transmission component 704 to transmit on the sidelink channel using the sidelink resources. In some aspects, the communication manager 140 may perform one or more operations described elsewhere herein as being performed by one or more components of the communication manager 140.

The communication manager 140 may include a controller/processor, a memory, or a combination thereof, of the UE described above in connection with FIG. 2. In some aspects, the communication manager 140 includes a set of components, such as a selection component 708, or a combination thereof Alternatively, the set of components may be separate and distinct from the communication manager 140. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The selection component 708 may use random selection to select sidelink resources when a CBR associated with a sidelink channel satisfies a CBR threshold. Accordingly, the transmission component 704 may transmit on the sidelink channel using the sidelink resources. Additionally, in some aspects, the selection component 708 may use partial sensing to select additional sidelink resources when an updated CBR associated with the sidelink channel fails to satisfy the CBR threshold. Accordingly, the transmission component 704 may transmit on the sidelink channel using the additional sidelink resources.

In some aspects, the selection component 708 may use partial sensing to select additional sidelink resources. Accordingly, the transmission component 704 may transmit an additional message on the sidelink channel using the additional sidelink resources. For example, the additional message may be associated with a priority that satisfies the priority threshold. In some aspects, the selection component 708 may apply a hidden node remediation when a BLER associated with the sidelink channel fails to satisfy a BLER threshold.

Alternatively, the selection component 708 may use partial sensing to select sidelink resources when a BLER associated with a sidelink channel fails to satisfy a BLER threshold. Accordingly, the transmission component 704 may transmit on the sidelink channel using the sidelink resources. Additionally, in some aspects, the selection component 708 may use random selection to select additional sidelink resources when an updated BLER associated with the sidelink channel satisfies the BLER threshold. Accordingly, the transmission component 704 may transmit on the sidelink channel using the additional sidelink resources.

In some aspects, the selection component 708 may use partial sensing to select additional sidelink resources. Accordingly, the transmission component 704 may transmit a message on the sidelink channel using the additional sidelink resources. For example, the message may be associated with a priority that satisfies a priority threshold. In some aspects, the selection component 708 may apply a hidden node remediation when a CBR associated with the sidelink channel satisfies a CBR threshold.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: using random selection to select sidelink resources when a channel busy ratio (CBR) associated with a sidelink channel satisfies a CBR threshold; and transmitting on the sidelink channel using the sidelink resources.

Aspect 2: The method of Aspect 1, wherein transmitting on the sidelink channel comprises: transmitting a message on the sidelink channel, wherein the message is associated with a priority that fails to satisfy a priority threshold.

Aspect 3: The method of Aspect 2, further comprising: using partial sensing to select additional sidelink resources; and transmitting an additional message on the sidelink channel using the additional sidelink resources, wherein the additional message is associated with a priority that satisfies the priority threshold.

Aspect 4: The method of any of Aspects 1 through 3, further comprising: using partial sensing to select additional sidelink resources when an updated CBR associated with the sidelink channel fails to satisfy the CBR threshold; and transmitting on the sidelink channel using the additional sidelink resources.

Aspect 5: The method of Aspect 4, wherein the updated CBR fails to satisfy the CBR threshold based on a hysteresis value.

Aspect 6: The method of any of Aspects 4 through 5, wherein using the partial sensing comprises: using the partial sensing when a block error ratio (BLER) associated with the sidelink channel fails to satisfy a BLER threshold.

Aspect 7: The method of any of Aspects 1 through 6, further comprising: applying a hidden node remediation when a block error ratio (BLER) associated with the sidelink channel fails to satisfy a BLER threshold.

Aspect 8: A method of wireless communication performed by a user equipment (UE), comprising: using partial sensing to select sidelink resources when a block error ratio (BLER) associated with a sidelink channel fails to satisfy a BLER threshold; and transmitting on the sidelink channel using the sidelink resources.

Aspect 9: The method of Aspect 8, further comprising: using partial sensing to select additional sidelink resources; and transmitting a message on the sidelink channel using the additional sidelink resources, wherein the message is associated with a priority that satisfies a priority threshold.

Aspect 10: The method of any of Aspects 8 through 9, further comprising: using random selection to select additional sidelink resources when an updated BLER associated with the sidelink channel satisfies the BLER threshold; and transmitting on the sidelink channel using the additional sidelink resources.

Aspect 11: The method of Aspect 10, wherein the updated BLER satisfies the BLER threshold based on a hysteresis value.

Aspect 12: The method of any of Aspects 10 through 11, wherein using the random selection comprises: using the random selection when a channel busy ratio (CBR) associated with the sidelink channel satisfies a CBR threshold.

Aspect 13: The method of any of Aspects 8 through 12, further comprising: applying a hidden node remediation when a channel busy ratio (CBR) associated with the sidelink channel satisfies a CBR threshold.

Aspect 14: An apparatus for wireless communication at a device, comprising a processor; memory coupled with the processor; and instructions stored in the memory and executable by the processor to cause the apparatus to perform the method of one or more of Aspects 1-7.

Aspect 15: A device for wireless communication, comprising a memory and one or more processors coupled to the memory, the one or more processors configured to perform the method of one or more of Aspects 1-7.

Aspect 16: An apparatus for wireless communication, comprising at least one means for performing the method of one or more of Aspects 1-7.

Aspect 17: A non-transitory computer-readable medium storing code for wireless communication, the code comprising instructions executable by a processor to perform the method of one or more of Aspects 1-7.

Aspect 18: A non-transitory computer-readable medium storing a set of instructions for wireless communication, the set of instructions comprising one or more instructions that, when executed by one or more processors of a device, cause the device to perform the method of one or more of Aspects 1-7.

Aspect 19: An apparatus for wireless communication at a device, comprising a processor; memory coupled with the processor; and instructions stored in the memory and executable by the processor to cause the apparatus to perform the method of one or more of Aspects 8-13.

Aspect 20: A device for wireless communication, comprising a memory and one or more processors coupled to the memory, the one or more processors configured to perform the method of one or more of Aspects 8-13.

Aspect 21: An apparatus for wireless communication, comprising at least one means for performing the method of one or more of Aspects 8-13.

Aspect 22: A non-transitory computer-readable medium storing code for wireless communication, the code comprising instructions executable by a processor to perform the method of one or more of Aspects 8-13.

Aspect 23: A non-transitory computer-readable medium storing a set of instructions for wireless communication, the set of instructions comprising one or more instructions that, when executed by one or more processors of a device, cause the device to perform the method of one or more of Aspects 8-13.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A method of wireless communication performed by a user equipment (UE), comprising:
using random selection to select sidelink resources when a channel busy ratio (CBR) associated with a sidelink channel satisfies a CBR threshold; and
transmitting on the sidelink channel using the sidelink resources.

2. The method of claim 1, wherein transmitting on the sidelink channel comprises:
transmitting a message on the sidelink channel,
wherein the message is associated with a priority that fails to satisfy a priority threshold.

3. The method of claim 2, further comprising:
using partial sensing to select additional sidelink resources; and
transmitting an additional message on the sidelink channel using the additional sidelink resources, wherein the additional message is associated with a priority that satisfies the priority threshold.

4. The method of claim 1, further comprising:
using partial sensing to select additional sidelink resources when an updated CBR associated with the sidelink channel fails to satisfy the CBR threshold; and
transmitting on the sidelink channel using the additional sidelink resources.

5. The method of claim 4, wherein the updated CBR fails to satisfy the CBR threshold based on a hysteresis value.

6. The method of claim 4, wherein using the partial sensing comprises:
using the partial sensing when a block error ratio (BLER) associated with the sidelink channel fails to satisfy a BLER threshold.

7. The method of claim 1, further comprising:
applying a hidden node remediation when a block error ratio (BLER) associated with the sidelink channel fails to satisfy a BLER threshold.

8. A method of wireless communication performed by a user equipment (UE), comprising:
using partial sensing to select sidelink resources when a block error ratio (BLER) associated with a sidelink channel fails to satisfy a BLER threshold; and
transmitting on the sidelink channel using the sidelink resources.

9. The method of claim 8, further comprising:
using partial sensing to select additional sidelink resources; and
transmitting a message on the sidelink channel using the additional sidelink resources, wherein the message is associated with a priority that satisfies a priority threshold.

10. The method of claim 8, further comprising:
using random selection to select additional sidelink resources when an updated BLER associated with the sidelink channel satisfies the BLER threshold; and
transmitting on the sidelink channel using the additional sidelink resources.

11. The method of claim 10, wherein the updated BLER satisfies the BLER threshold based on a hysteresis value.

12. The method of claim 10, wherein using the random selection comprises:
using the random selection when a channel busy ratio (CBR) associated with the sidelink channel satisfies a CBR threshold.

13. The method of claim 8, further comprising:
applying a hidden node remediation when a channel busy ratio (CBR) associated with the sidelink channel satisfies a CBR threshold.

14. An apparatus for wireless communication at a user equipment (UE), comprising:
a memory; and
one or more processors, coupled to the memory, configured to:
use random selection to select sidelink resources when a channel busy ratio (CBR) associated with a sidelink channel satisfies a CBR threshold; and
transmit on the sidelink channel using the sidelink resources.

15. The apparatus of claim 14, wherein the one or more processors, to transmit on the sidelink channel, are configured to:
transmit a message on the sidelink channel,
wherein the message is associated with a priority that fails to satisfy a priority threshold.

16. The apparatus of claim 15, wherein the one or more processors are further configured to:
use partial sensing to select additional sidelink resources; and
transmit an additional message on the sidelink channel using the additional sidelink resources, wherein the additional message is associated with a priority that satisfies the priority threshold.

17. The apparatus of claim 14, wherein the one or more processors are further configured to:
use partial sensing to select additional sidelink resources when an updated CBR associated with the sidelink channel fails to satisfy the CBR threshold; and
transmit on the sidelink channel using the additional sidelink resources.

18. The apparatus of claim 17, wherein the updated CBR fails to satisfy the CBR threshold based on a hysteresis value.

19. The apparatus of claim 17, wherein the one or more processors, to use the partial sensing, are configured to:
use the partial sensing when a block error ratio (BLER) associated with the sidelink channel fails to satisfy a BLER threshold.

20. The apparatus of claim 14, wherein the one or more processors are further configured to:
apply a hidden node remediation when a block error ratio (BLER) associated with the sidelink channel fails to satisfy a BLER threshold.

21. An apparatus for wireless communication at a user equipment (UE), comprising:
a memory; and
one or more processors, coupled to the memory, configured to:
use partial sensing to select sidelink resources when a block error ratio (BLER) associated with a sidelink channel fails to satisfy a BLER threshold; and
transmit on the sidelink channel using the sidelink resources.

22. The apparatus of claim 21, wherein the one or more processors are further configured to:
use partial sensing to select additional sidelink resources; and
transmit a message on the sidelink channel using the additional sidelink resources, wherein the message is associated with a priority that satisfies a priority threshold.

23. The apparatus of claim 21, wherein the one or more processors are further configured to:
use random selection to select additional sidelink resources when an updated BLER associated with the sidelink channel satisfies the BLER threshold; and
transmit on the sidelink channel using the additional sidelink resources.

24. The apparatus of claim 23, wherein the updated BLER satisfies the BLER threshold based on a hysteresis value.

25. The apparatus of claim 23, wherein the one or more processors, to use the random selection, are configured to:
use the random selection when a channel busy ratio (CBR) associated with the sidelink channel satisfies a CBR threshold.

26. The apparatus of claim 21, wherein the one or more processors are further configured to:
apply a hidden node remediation when a channel busy ratio (CBR) associated with the sidelink channel satisfies a CBR threshold.
